(19) United States
(12) Patent Application Publication
(10) Pub. No.: US 2015/0014980 A1
(43) Pub. Date: Jan. 15, 2015

(54) METHOD AND SYSTEM FOR AUTHENTICATING PRINTED DOCUMENTS

(71) Applicant: CRIMSON LOGIC PTE LTD, Singapore (SG)

(72) Inventors: Yash Sunit Joshi, Singapore (SG); Thio Fu Wang, Singapore (SG)

(73) Assignee: CRIMSON LOGIC PTE LTD, Singapore (SG)

(21) Appl. No.: 14/218,350

(22) Filed: Mar. 18, 2014

Related U.S. Application Data
(60) Provisional application No. 61/843,082, filed on Jul. 5, 2013.

(51) Int. Cl. B42D 25/30; B42D 25/40

(52) U.S. Cl. CPC B42D 25/30; B42D 25/40
USPC 283/67; 283/85

(57) ABSTRACT

Method of providing an authenticated printed document including generating a message image by applying conversion parameters to text, the message image being defined by pixels and including converted text in a first color and a background in a second color; generating a first pixel array of the same pixel size as the image by selecting a sub-pixel configuration for each pixel of the first array; generating a second pixel array corresponding to the first array. The pixel of the image is in the second color, a first sub-pixel configuration for the second array is identical to the configuration selected for the first array, or where the pixel of the image is the first color, a second sub-pixel configuration generated for the second array is inverted relative to the configuration for the first array, such that the converted text is hidden in the second array; transferring the second array to the document; providing the first array on a transparent medium for superimposing on the second array on the document to reveal the converted text.

### FIELD OF THE INVENTION

This invention generally relates to the field of visual cryptography and particularly to a method and system for authenticating printed documents.

### BACKGROUND

Printed documents often need to be verified to confirm that they have been issued from a particular source and that the contents have not been tampered with. Such authentication can be used for various printed documents such as transcripts, diplomas, certificates and the like in the academic field; shares and bonds certificates, insurance policies, statements of account, letters of credit, legal forms and the like in the financial field; immigration visas, titles, financial instruments, contracts, licenses and permits, classified documents and the like in the government field; prescriptions, control chain management, medical forms, vital records, printed patient information and the like in the health care field; schematics, cross-border trade documents, internal memos, business plans, proposals, designs and the like in the business field; tickets, postage stamps, manuals and books, coupons, gift certificates, receipts, and the like in the consumer field; and many other applications and fields.

Cryptography, which includes encryption and decryption, involves disguising a message so that only certain people can recognize the message. Generally, encryption systems perform an encryption operation on a plain text message using an encryption key to produce a ciphertext message. The receiver of a ciphertext message performs a corresponding decryption operation with a decryption system using a decryption key to recover the plain text block.

The operations of such cryptosystems commonly make use of computers but may also be performed visually, chemically, or by other non-traditional means. U.S. Pat. No. 5,488,664 to Shamir discloses an encryption method that recovers plain text by stacking one transparency with the ciphertext printed on it and another transparency with the encryption key printed on it. Such a printed ciphertext requires no computation to decode—the naked eye can see the hidden message when the transparencies are aligned.

The principle behind visual cryptography can be described as follows. An image is split into two converted parts, the image plus a randomization and the randomization itself. Either part individually contains no information on the original image because of the randomization. However, when both parts are physically overlaid, the original image is reconstructed. If the two parts do not share the same randomization, no information on the original image is revealed and a random image is produced. If two parties want to communicate using visual cryptography, they have to share the randomization.

In practice, the sender would convey to the receiving party a transparency (lens) containing the randomization. The sender would then use the same randomization on the original image, and print the resulting image (cryptogram). The receiving party can recover the original image by using the randomization.

The original image can be an arbitrary image or (more often) an image representation of a message text. We consider only monochrome images for simplicity: the original (message) image is, in general, a rectangular array of black and white pixels.

In order to construct the cryptogram, each pixel of the image, processed independently, is split into two sets of sub-pixels. The image is thus divided into two collections of sub-pixels. One collection appears in the printed cryptogram and one collection appears in the decryption lens, wherein black sub-pixels are opaque and white sub-pixels are transparent. When the lens is placed over the cryptogram, a superimposed collection of sub-pixels is seen at each pixel, corresponding to the union of the black sub-pixels in each of the two collections. The sub-pixels in each collection are printed in close proximity to each other so that the human visual system averages their black/white contributions. The superimposed collection of black sub-pixels visually reveals the message image.

Any cryptogram can be decoded (i.e. the original image recovered) by overlaying a given transparency as long as the randomization represented by the given transparency is the same as the randomization used to create the cryptogram.

The idea of hiding visual information is not restricted to transparency or printed media. Due to the widespread and prevalent use of electronic media, there are numerous examples of prior art that apply the concept to electronic documents, such as a decryption key being an electronic device having an electronic display screen and aligned with the electronic document displayed on a separate screen. However, despite the advances of modern computer technology, the use of printed media is still relevant today particularly in areas where electronic equipment is not easily accessible or available or organizations simply prefer the use of printed media over electronic media for certain business processes.

It is thus useful to apply visual cryptography to the authentication of printed documents. However, in a real world environment, the authentication of printed documents using visual cryptography presents some shortcomings

A basic implementation of visual cryptography would require the sender to convey to the receiving party a transparency containing the lens (i.e. randomization). The sender would also use the same randomization to randomize the original messages and construct the cryptograms for various documents. However, if an attacker in possession of a cryptogram-containing document knows the hidden message text, it is possible for the attacker to derive, at least approximately, the lens. One way of doing this is by representing the message text as an image, and to pixel-wise construct the lens so that when the constructed lens is superimposed on the cryptogram, it reveals the required message image. Once the lens is successfully reconstructed, the security of the system is compromised since the reconstructed lens can be used to forge documents having cryptograms containing arbitrary hidden messages, with these cryptograms being decodable by the lens.

In another scenario, the security of the system can be compromised if employees within an organization have access to the decryption lens or copies thereof. For example, end users may print their own documents and a distributed network of agencies may authenticate the documents, making it possible for corrupt agency employees to forge documents containing unauthorized information within a valid cryptogram, such as constructing a printed document containing concocted information that appears to be verified when the cryptogram is decoded using a lens.

There is therefore an increasing need to address the deficiencies or shortcomings of basic visual cryptography as applied to document authentication scenarios as presented above.

### SUMMARY OF THE INVENTION

According to a first aspect of the invention, there is provided a method of providing a printed document that can be visually authenticated, comprising the steps of: generating a message image by applying conversion parameters to a text, the message image being defined by pixels and the message image including a converted text in a first color and a background in a second color; generating a first pixel array of the same pixel size as the message image by selecting a predefined sub-pixel configuration for each pixel of the first pixel array; generating a second pixel array corresponding to the first pixel array, wherein where the pixel of the message image is in the second color, a first sub-pixel configuration generated for the second pixel array is identical to the predefined sub-pixel configuration selected for the first pixel array, or where the pixel of the message image is in the first color, a second sub-pixel configuration generated for the second pixel array is inverted relative to the predefined sub-pixel configuration selected for the first pixel array, such that the converted text is hidden in the second pixel array; transferring the second pixel array to the printed document; providing the first pixel array rendered on a transparent medium to a user for superimposing on the second pixel array located on the printed document to reveal the converted text to the user.

Preferably, the method further comprises the step of generating a plurality of second pixel arrays, each of which includes the message image having the converted text, wherein the conversion parameters applied to each message image is not identical to one another resulting in the converted text not being identical to one another.

Preferably, applying the conversion parameters to the text includes selecting the conversion parameters in a random manner to be applied to individual characters of the text to generate the converted text.

Preferably, the conversion parameters include a font, a font size, a position or an orientation of the text or any combination thereof.

Preferably, the step of generating a message image by applying conversion parameters to the text further includes the step of selecting a vertical and horizontal pixel size for the message image.

Preferably, the converted text of each of the message images includes a font, font size, position or orientation of the text, or any combination thereof, which is not identical to the converted text of other message images.

Preferably, the converted text of each of the message images includes individual characters, each of which is of a font, font size, position or orientation of the text, or any combination thereof, which is not identical to the converted text of other message images.

Preferably, the predefined sub-pixel configuration comprises a square two by two configuration of four sub-pixels of which two are in the first color and two are in the second color.

Preferably, the first pixel array and second pixel array includes a guide mark on the same corresponding location of the first pixel array and the second pixel array for guiding the user to superimpose the first pixel array on the second pixel array.

Preferably, the method further comprises a step of: transferring a plurality of second pixel arrays on a printed document, wherein each of the second pixel arrays include the message image having the converted text, wherein the conversion parameters applied to each message image is not identical to one another.

Preferably, the step of generating the message image further includes generating a character or text or a combination of character or text such that the message image includes the character or text or combination of character or text.

According to a second aspect of the invention, there is provided a method of providing printed documents that can be visually authenticated, comprising the steps of: generating a plurality of message images by applying conversion parameters to a text, each of the message images being defined by pixels and each of the message images comprising a converted text in a first color and a background in a second color; generating a first pixel array of the same pixel size as each of the message images by selecting a predefined sub-pixel configuration for each pixel of the first pixel array; generating a plurality of second pixel arrays, each corresponding to the first pixel array, and each of the second pixel arrays corresponding to one of the message images, wherein for each of the second pixel arrays, where the pixel of the message images is in the second color, a first sub-pixel configuration generated for the second pixel array is identical to the predefined sub-pixel configuration selected for the first pixel array, or where the pixel of the message images is in the first color, a second sub-pixel configuration generated for the second pixel array is inverted relative to the predefined sub-pixel configuration selected for the first pixel array, such that the converted text is hidden in each of the second pixel arrays; transferring each of the second pixel arrays to each printed document; providing the first pixel array rendered on a transparent medium to a user for superimposing on each of the second pixel arrays to reveal each converted text to the user.

Preferably, applying the conversion parameters to the text includes selecting the conversion parameters in a random manner to be applied to individual characters of the text to generate the converted text, wherein the conversion parameters applied to each message image is not identical to one another.

Preferably, the conversion parameters include a font, a font size, a position or an orientation of the text or any combination thereof.

Preferably, the step of generating a plurality of message images by selecting conversion parameters further includes the step of selecting a vertical and horizontal pixel size for each of the message images.

Preferably, the converted text of each of the message images includes a font, font size, position or orientation of the text, or any combination thereof, which is not identical to the converted text of another message image.

Preferably, the converted text of each of the message images includes individual characters, each of a font, font size, position or orientation of the text, or any combination thereof, which is not identical to the converted text of another message image.

Preferably, the predefined sub-pixel configuration comprises a square two by two configuration of four sub-pixels of which two are in the first color and two are in the second color.

Preferably, the first pixel array and second pixel array includes a guide mark on the same corresponding location of the first pixel array and the second pixel array for guiding the user to superimpose the first pixel array on the second pixel array.

Preferably, the step of generating the plurality of message images further includes generating a character or text or a combination of character or text on each message image such that each of the message images includes the character or text or combination of character or text.

According to a third aspect of the invention, there is provided a method of providing printed documents that can be visually authenticated, comprising the steps of: generating a plurality of message images by applying conversion parameters to a text, each of the message images being defined by pixels and each of the message images comprising a converted text in a first color and a background in a second color; generating a first pixel array of the same pixel size as each of the message images by selecting a predefined sub-pixel configuration for each pixel of the first pixel array; generating a plurality of second pixel arrays, each corresponding to the first pixel array, and each of the second pixel arrays corresponding to one of the message images wherein for each of the second pixel arrays, where the pixel of the message images is in the second color, a first sub-pixel configuration generated for the second pixel array is identical to the predefined sub-pixel configuration selected for the first pixel array, or where the pixel of the message images is in the first color, a second sub-pixel configuration generated for the second pixel array is inverted relative to the predefined sub-pixel configuration selected for the first pixel array, such that the converted text is hidden in each of the second pixel arrays; transferring the first pixel array to each printed document; providing each of the second pixel arrays printed on a transparent sheet of material to multiple users for superimposing on the first pixel array to reveal the converted text to each of the multiple users.

According to a fourth aspect of the invention, there is provided a system for providing documents that can be visually authenticated, comprising: A system for providing documents that can be visually authenticated, comprising: a text converter for converting a text to a plurality of message images by applying conversion parameters to the text to convert the text into the plurality of message images, wherein each of the message images is defined by pixels, and each of the message images includes a converted text in a first color and a background in a second color, the converted text in each of the message images are not identical to one another; a first pixel array generator for generating a first pixel array of the same pixel size as each of the plurality of message images by selecting a predefined sub-pixel configuration for each pixel of the first pixel array; a second pixel array generator for generating a plurality of second pixel arrays, each corresponding to the first pixel array, and each of the second pixel arrays corresponding to one of the message images, wherein for each of the second pixel arrays, where the pixel of the message images is in the second color, a first sub-pixel configuration generated for the second pixel array is identical to the predefined sub-pixel configuration selected for the first pixel array, or where the pixel of the message images is in the first color, a second sub-pixel configuration generated for the second pixel array is inverted relative to the predefined sub-pixel configuration selected for the first pixel array, such that the converted text is hidden in each of the second pixel arrays; a printing element for transferring each of the second pixel arrays to printed documents and for transferring the first pixel array to a transparent sheet of material, the first pixel array for superimposing on each of the second pixel arrays on the printed documents to reveal the converted text.

Preferably, applying the conversion parameters to the text includes selecting the conversion parameters in a random manner to be applied to individual characters of the text to generate the converted text.

Preferably, the conversion parameters of the text include a font, a font size, a position or an orientation of the text or any combination thereof.

Preferably, each of the message images has a vertical and horizontal pixel size.

Preferably, the converted text includes a font, font size, position or orientation of the text, or any combination thereof, which is not identical to the converted text of another message image.

Preferably, the predefined sub-pixel configuration comprises a square two by two configuration of four sub-pixels of which two are in the first color and two are in the second color.

Preferably, the first pixel array and second pixel array includes a guide mark on the same corresponding location of the first pixel array and the second pixel array for guiding the user to superimpose the first pixel array on the second pixel array.

According to a fifth aspect of the invention, there is provided a method of providing printed documents that can be visually authenticated, comprising the steps of: A method of providing printed documents that can be visually authenticated, comprising the steps of: generating a plurality of message images by applying conversion parameters to a plurality of texts, each of the message images being defined by pixels and each of the message images comprising a converted text in a first color and a background in a second color; generating a first pixel array of the same pixel size as each of the message images by selecting a predefined sub-pixel configuration for each pixel of the first pixel array; generating a plurality of second pixel arrays, each corresponding to the first pixel array, and each of the second pixel arrays corresponding to one of the message images, wherein for each of the second pixel arrays, where the pixel of the message images is in the second color, a first sub-pixel configuration generated for the second pixel array is identical to the predefined sub-pixel configuration selected for the first pixel array, or where the pixel of the message images is in the first color, a second sub-pixel configuration generated for the second pixel array is inverted relative to the predefined sub-pixel configuration selected for the first pixel array, such that the converted text is hidden in each of the second pixel arrays; transferring each of the second pixel arrays to each printed document; providing the first pixel array rendered on a transparent medium to a user for superimposing on each of the second pixel arrays to reveal each converted text to the user.

### BRIEF DESCRIPTION OF THE DRAWINGS

In order that embodiments of the invention may be fully and more clearly understood by way of non-limitative examples, the following description is taken in conjunction with the accompanying drawings in which like reference numerals designate similar or corresponding elements, regions and portions, and in which:

FIG. 1 shows the authentication process of a message text in accordance with an embodiment of the invention;

FIG. 2 shows the authentication process of another message text in accordance with an embodiment of the invention; and

FIG. 3 shows a system for authentication of printed documents in accordance with an embodiment of the invention.

### DETAILED DESCRIPTION

In the following description, the detailed embodiments of the present invention are described herein. It shall be apparent to those skilled in the art, however, that the embodiments are not intended to be limiting to the embodiments described but merely as the basis for the claims and for teaching one skilled in the art how to make and/use the invention. Some details of the embodiments are not described at length so as not to obscure the present invention.

In the context of the embodiments disclosed herein, although ‘text’ refers to characters, words, numbers or symbols or any combination thereof in any language, script, or notation, an image or images in the form of representations of the external form of a person or thing, can also be utilized for the purposes of the embodiments disclosed. Therefore, although ‘text’ has been used consistently throughout the specification, the words ‘text’ and ‘image’ are interchangeable.

A method and system is disclosed which provides authentication of originality of a printed document and verification that the printed document content is unaltered.

As an initial step, a message text is identified. The message text can include various items of information related to the document, including but not limited to the user account of the print issuer, the internet address of the issuing computer, the date and time of printing, or the document serial number. It can also include information specified by the print issuer, or information retrieved from the document contents.

The message text is converted into a message image. Details of how the message image is generated from the message text 10, along with the rationale behind this process, will be explained later.

Based on the visual cryptography process as illustrated by Shamir, the message image is split or shared into two pixel arrays (shares) such that physically superimposing or overlaying these shares results in the recreation of the message image.

In order to achieve this, each pixel in the message image is mapped to a sub-pixel configuration, which is a square 2×2 configuration of four sub-pixels of which two are black and two white. There are six such sub-pixel configurations. These sub-pixel configurations may be assigned numbers from 1 to 6.

To generate the first image share, a random sub-pixel configuration is chosen for each and every pixel of the message image. The random choice can be represented by a number from 1 to 6 corresponding to the sub-pixel configuration; the sequence of random numbers corresponding to the pixels of the image defines the randomization applied to this image.

To generate the second image share, each pixel of the message image is considered in turn. If the pixel in the message image was white, the sub-pixel configuration for the pixel of the second share is chosen to be the same as the sub-pixel configuration for the pixel of the first share. If the pixel in the message image was black, the sub-pixel configuration for the pixel of the second share is chosen to be inverted, i.e. opposite in colour, relative to the first share.

Processing each pixel in this way, two image shares are formed. Neither share individually reveals any information about the message image. In all cases, two of the four sub-pixels chosen to represent a message image pixel are black and the other two are white. This results in both shares looking gray in color since the human visual system averages the contributions of the black and white pixels. One of the shares is printed on a transparency in order to allow it to be superimposed on the other.

To reconstruct the image, the two shares are superimposed. For pixels that were black in the message image, the superimposition of the two inverted sub-pixel configurations results in an “interlocking” of the black sub-pixels, leading to a perceived dark pixel. For pixels that were white in the message image, the superposition of the two identical sub-pixel configurations results in an “overlapping” of the black sub-pixels, leading to a perceived lighter (half-black) pixel. Thus, an approximation of the message image is reconstructed.

If the two shares were not constructed using the same randomization, the message image is not revealed by the superimposition of the two shares.

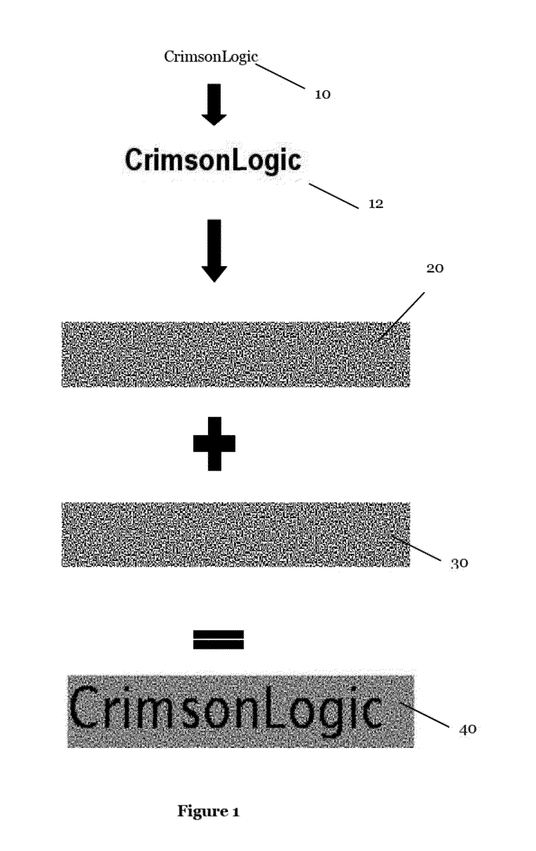

FIG. 1 shows a message text 10 “CRIMSONLOGIC”, a message image 12, two shares 20, 30 and a reconstructed message image 40. The message image 12 is a visual representation of the message text 10. The message image 12 is the message to be hidden. Details on how the message image 12 is generated from the message text 10 will be explained later. As can be seen, the first share 20, illustrates a first pixel array, each of the pixels comprising a sub-pixel configuration randomly assigned as described above, and forming a secured area or a typical printed cryptogram. The second share, 30, illustrates a second pixel array, each of the pixels comprising sub-pixel configurations which are assigned accordingly as detailed above, forming a lens. The functions of the first pixel array and the second pixel array are interchangeable, i.e. the first pixel array can be the lens and the second pixel array can the cryptogram. The message image 12 is completely invisible in each of the two pixel arrays. The first and second pixel arrays 20, 30 are rectangles where each pixel is formed of sub-pixel configurations. The first share 20 and the second share 30 are obtained by applying visual cryptography to the message image 12. By superimposing the first share 20 and the second share 30, the reconstructed message image 40 appears. It should be noted that the reconstructed message image 40 is not identical to the message image 12. The white parts of the message image 12 consist of a randomized black and white pattern in the reconstructed message image 40.

In an embodiment of the invention, the cryptogram is printed on a physical document such as a sheet of material, and the text 10 is a document identifier or end recipient identifier. The physical document is the secured document. The lens is printed on a transparent sheet of material or rendered on a transparent medium. It is possible to generate a new lens-cryptogram combination for each document; however, this is not practical. A more realistic scenario involves the use of a single lens that can verify a number of documents.

A single-lens, multiple-cryptogram scenario can be devised using the following procedure. As mentioned above, to generate the first pixel array, a random sub-pixel configuration is chosen for each and every pixel of the message image. This first pixel array is considered to be the lens, and is considered fixed. As described above, to generate the second pixel array, each pixel of the message image is considered in turn. Referring to FIG. 1, the message image 12 (“CrimsonLogic”) includes a converted text (i.e. “CrimsonLogic”) in black colour and a background space in white colour. The derivation of the converted text will be explained in more details below. If the pixel in the message image is white, i.e. the background space, the sub-pixel configuration for the second pixel array is chosen to be the same as the sub-pixel configuration for the pixel of the first pixel array. If the pixel in the message image is black, i.e. the converted text, the sub-pixel configuration chosen for the second pixel array is inverted relative to the sub-pixel configuration of the first pixel array.

A single-lens, multiple-cryptogram deployment can be used, for example, to enable an organization to verify all the documents printed by its employees while not allowing the organization to decode documents printed by other organizations (which would use different lenses).

The problem of using the same fixed lens for many documents is that the security of the system may be compromised by an attacker who has a document containing a cryptogram. (It is noted that many individuals, including end users, would have such a document.) Such an attacker may derive the lens by reconstructing the lens pixel by pixel from the hidden message (typically a document or end recipient identifier, which may be known to the attacker or visible on the document) and the cryptogram. The attacker can derive a lens that, when superimposed on the known cryptogram, reveals the known message image. This is achievable using elementary logic: for each pixel that needs to be black in the hidden message image, the attacker can choose a sub-pixel configuration for the lens that interlocks with the sub-pixel configuration for the cryptogram; and for each pixel that needs to be white in the hidden message image, the attacker can choose a sub-pixel configuration for the lens that overlaps with the sub-pixel configuration for the cryptogram. The lens thus constructed will obviously reveal the message that the attacker wishes to reveal when it is overlaid on this known cryptogram. In this way, the attacker with the reconstructed lens would presumably be able to authenticate the cryptograms on other documents or, more dangerously, construct arbitrary forged documents with valid cryptograms.

The present invention addresses this problem by randomly varying the visual representation of a text in the message image during the conversion of the message text into the message image. As a result, even if the attacker knows the text 10, he cannot determine the actual hidden message image 12. Thus, an attacker who has purportedly reconstructed the lens pixel-wise using a message image 12 that is an intuitive representation of the message text 10 will find that his lens does not reveal the hidden message image on other documents with similar cryptograms, i.e. his reconstructed lens is not accurate.

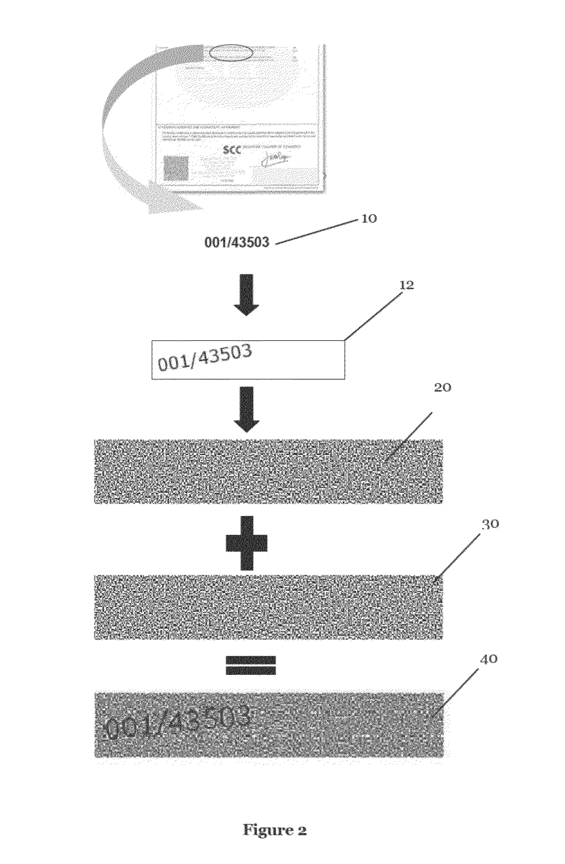

Referring to FIG. 2, the conversion of the message text 10 into the message image 12 is now explained and forms an important aspect of the invention. The message text 10, like any text, is a purely theoretical idea; what we see is a visual representation of the text (e.g. as represented by a font on the computer screen or in print). The conversion of the (theoretical) message text 10 to the message image 12 is determined by many conversion parameters including the font, font size, orientation, x-position and y-position within the image area, etc. A user may therefore know the text 10 but would not know how it is visually represented as the message image 12 in the cryptogram. A static (i.e. constant-parameter) conversion would result in a message image 12 created using the same parameters each time for all secure documents (as described in FIG. 1). However, by randomly varying these conversion parameters, the font, position, size and orientation of the text 10 in the message image 12 will be different for each document. This strengthens the cryptogram, since the attacker can no longer determine the message image 12 from his knowledge of text 10. Even if the same message text is printed on different secured documents, the message image will be different. FIG. 2 shows an example of a “non-intuitive” conversion of the message text 10 to a message image 12, such as may result from a random variation of the conversion parameters.

The invention thus makes it highly unlikely that an attacker will be able to reconstruct the correct lens. However, in all cases, when the correct lens is aligned with the cryptogram on the document, the reconstructed message image 40 will be revealed.

Referring to FIG. 2 again, in an embodiment of the invention, the text 10 is represented on the display interface, such as a computer screen, in the form of a text 10. For the text 10 to be displayed on the computer screen, the user will be prompted to input the text, which may include individual characters of the alphabet, numbers, mathematical symbols or operators via an input device such as a keyboard. Once the text is keyed in, the text 10 is displayed on the display interface. The text 10 is then converted to a message image 12 in two steps. In the first step, the user will be prompted to select a vertical and horizontal pixel size for the message image 12. The message image is made up of an array of pixels and is represented by the rectangular box in FIG. 2. The message image 12 can be represented in the shape of a rectangle or in other shapes that is practicable. In the second step, the user will generate the message image 12 by selecting conversion parameters in a random manner. The conversion parameters are applied to the text 10 to convert the text into the message image. The user can select the conversion parameters to be varied, such as selecting the orientation of the message image, selecting the type of font and selecting the font size. Individual characters of the text 10 can be converted individually, for example, one of the characters can be a font size 10 while the rest of the characters of the text have varying font sizes from 11-20. Alternatively, the algorithm can select the conversion parameters to be varied such that the message image 12 generated will never be identical to one that has been generated previously. The message image 12 that is generated is of the same pixel size selected in the previous step and includes the converted text in black color and the background space making up the pixel size in white color. The colors could be inverted, with the converted text in white color and the background space in black color. Alternatively, the colors could be of different contrasting colors. The message image 12 generated and applied on multiple secured documents will always be different even if the converted text is the same.

In another embodiment of the invention, the message text 10 is extracted from a document by means of a parsing or character recognition technique. The message text 10 is then converted into a message image 12 by the algorithm using randomized conversion parameters as above.

Once the message image 12 has been generated, the algorithm generates a first pixel array (first share 20) of the same vertical and horizontal pixel size as the message image 12. The first pixel array defines the lens. Each pixel in the first pixel array includes a sub-pixel configuration selected at random from one of the six possible 2×2 configurations of 2 black and 2 white sub-pixels, as described above.

The algorithm will then generate a second pixel array (second share 30), similarly made up of sub-pixel configurations like the first pixel array. The second pixel array includes the message image 12 invisible to the naked eye. The second pixel array is identical in pixel size to the first pixel array and the message image 12. The second pixel array will be generated pixel-by-pixel based on the first pixel array. If the corresponding pixel in the message image 12 is white, i.e., the white space of the message image 12 within the rectangular box in FIG. 2, the sub-pixel configuration of the second pixel array in that position will be identical to the sub-pixel configuration of the first pixel array in the same position. If the corresponding pixel in the message image 12 is black, i.e., the visual representation of the text in black, the sub-pixel configuration at that position in the second pixel array will be inverted in comparison to the sub-pixel configuration of the first pixel array in the same position. In this way, the message image 12 will appear invisible to the naked eye in the second pixel array. The second pixel array is then printed on a physical document via a printer and forms the cryptogram.

The algorithm will continue to generate multiple second pixel arrays or second shares 30 according to the desired needs of the user. Each of the second pixel arrays will include a message image 12 that contains a converted text that is different from the converted text of another message image 12 as a result of the conversion parameters being applied randomly to the text. The first pixel array (lens) is transferred or rendered to a transparent medium and is then used by a user or a group of users for superimposing on the second pixel array on the printed document in order to reveal the message image 12. The transparent medium can be a sheet of transparent material or electronically rendered on a transparent liquid crystal display. In this way, the lens is fixed and can be used on multiple printed documents having the second pixel arrays, each of which contains different message images.

An attacker may attempt to reconstruct the lens (first pixel array or first share 20) based on his knowledge of the text 10 of a secured document or of prior knowledge of a successful authentication of a prior printed document having the cryptogram (second pixel array or second share 30). However, he will not know the conversion parameters applied to convert the text 10 nor the converted text in other cryptograms, and thus when the reconstructed lens is superimposed on these other cryptograms, the converted text in the message image will not be revealed.

In another embodiment of the invention, the cryptogram on the secured document may reveal the converted text and an additional hidden character or combination of hidden characters when the lens is aligned, these characters being separate from the actual message. Using the same scenario above, the user who attempts to reconstruct the lens and constructs his own document with unauthorized data may not account for the hidden character or combination of hidden characters in the cryptogram. If the cryptogram is forged with the reconstructed lens, the alignment of a lens will reveal the absence of the hidden character or combination of hidden characters, thereby drawing the suspicion of the user of the real lens. The additional character or text or combination of characters or text are generated when generating the message image. This is done by including the character or text in the vicinity of the converted text in the message image. The character or text will be within the background space of the message image. Upon generating the cryptogram, the character or text will not be visible to the naked eye as it will go through the formation of sub-pixel configuration corresponding with the lens as described above.

In another embodiment of the invention, instead of the first pixel array being the lens and the second pixel array being transferred to printed documents, the first pixel array is transferred to the printed document and multiple second pixel arrays for use as lens are generated for distribution to multiple users to authenticate the printed document. In this case, the multiple second pixel arrays are the lens for superimposing on the first pixel array on the printed document. Each multiple second pixel arrays when superimposed on the first pixel array will reveal a different message image.

In yet another embodiment of the invention, a combination of at least two cryptograms can be generated on one secured document. The cryptograms can be positioned side by side or one within the other. It is possible that other configurations of positioning the cryptograms are envisaged and not limited to the aforesaid positions. The message images in the cryptograms on the same secured document are revealed by different lens. This provides additional security against an insider job. One of the cryptograms can be decrypted by a group of personnel and the other cryptogram can be decrypted by a separate group of personnel within the same organization but in different departments. The group of personnel may also be of varying levels of hierarchy within an organization. If suspicion is raised by a lower level employee on the authenticity of a secured document, the secured document can be sent to a higher level employee for verification of the authenticity of the secured document.

In yet another embodiment of the invention, the method includes customizing the lens or the cryptogram to ensure perfect alignment where the secured documents can be printed from different printers. Secured documents can be printed on a first printer and authenticated using a lens that is printed on a second printer wherein the first printer is not the same as the second printer. In this case, the cryptogram and the lens may not be printed in exactly the same size and shape which can prevent the message image from being revealed clearly when the lens is aligned with the cryptogram. In order to prevent errors of this nature, the lens or the cryptogram can be scaled up or down, typically by extremely small factors, along either or both axes at printing time so that the lens can be correctly aligned with the cryptogram to reveal the message image. The choice of scale can be made manually through a benchmarking process, where cryptograms and lens of different scales are aligned and the clarity of the result examined to arrive at the optimal scaling factors.

In yet another embodiment of the invention, the method includes adding a guide mark or printed structure to help the user align the lens and the cryptogram. The guide mark is printed at the same relative location on both lens and cryptogram, and the user aligns the guide marks on both lens and cryptogram. The guide mark can take the form of a crosshair, bull's-eye, or any other shape. Any number of guide marks can be used at any relative position to the cryptogram.

In yet another embodiment of the invention, a customized lens is generated for each organization or company or departments within an organization. This is to ensure that no one organization or company or department will have the same lens. To generate a distinct and different lens for each organization, each organization is given a unique identification number. As mentioned above, the lens with the array of sub-pixel configurations provides the reference for the cryptogram to be generated. The array of sub-pixel configuration on the lens is determined by the chosen sequence of sub-pixel configurations. For each unique identification number tied to an organization, a random sequence of numbers from 1 to 6 can be generated by using the unique identification number as a seed. Each number in this random sequence can be used to choose a sub-pixel configuration of the six available choices to define an organization-specific lens.

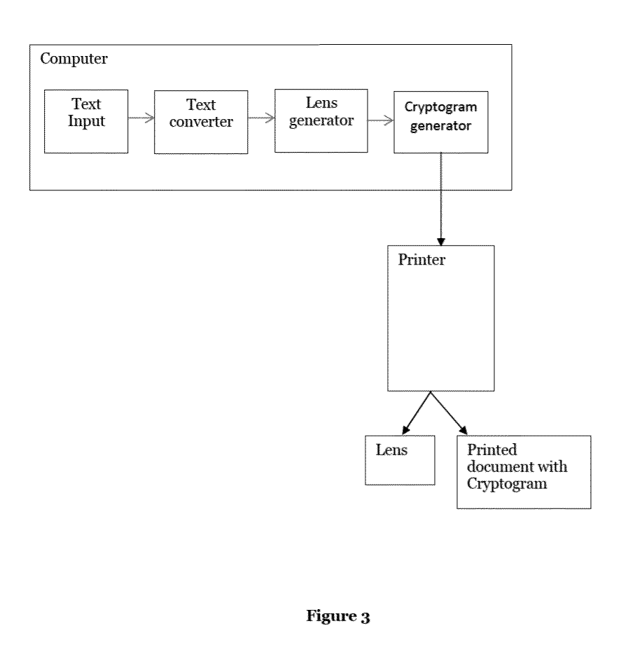

FIG. 3 represents a block diagram incorporating a system of an embodiment of the present invention. A computer system is operable with a printer device to generate a printed document with the cryptogram. The computer system may store and execute a program for generating the cryptogram with message image 12. The computer system may be any of various types of computing or processing systems, including a personal computer system, mainframe computer system, workstation, network appliance, internet applicant or any electronic device with a processor. The program includes any type of program instructions, code, script and/or data, or combinations thereof that may be stored in a memory medium and executed by a processor. A software program may include two or more software programs that interoperate with one another to perform the intended functions.

The program includes a text input, text converter and a cryptogram generator. The text input allows extraction of text from a separate electronic document, or a user to selectively input a desired text. The text converter converts a text 10 to a message image 12 by randomly varying the parameters of the text. The text is a word which can comprise letters, numerals and symbols in any language, script, or notation. The text converter randomly varies the font, font size, position, orientation, or any combination thereof, to generate message images from the text. The message image includes a converted text and a background space. The converted text and the background space are in contrasting colours so that the converted text is legible and identifiable. The message images generated by the text converter are not identical to one another so that the converted text resulting from the text converter will never be identical. As described above, this enhances the authentication process and thereby security of the document to be generated. A lens generator is also included in the program to generate a lens for authentication. The lens, depending on the embodiments described above, can be the first pixel array or the second pixel array. The lens is generated by generating a pixel array that is the same size as the message image. As described above, the sub-pixel configuration can be chosen by the user or randomly selected for each pixel of the pixel array.

The cryptogram generator produces cryptograms with the message image embedded within the cryptogram as described above. Each message image (i.e, the converted text and background space) generated by the text converter will be hidden within each cryptogram so that the message image will not be visible to the naked eye and revealed only upon the superimposition of the lens. Using visual cryptography, the cryptogram generator generates each cryptogram and message image using its knowledge of the lens, which may be fixed and identical for multiple cryptograms.

Once the cryptogram is generated by the program, it is ready to be printed on a secured document. A printing device that is inter-operably connected with the computer system allows the secured document to be printed with each cryptogram. The corresponding lens can be printed and distributed to an external party or within the same company to authenticate the secured document by superimposing the lens on the cryptogram to reveal the message image. In this way, the same lens can be used by various parties without the inconvenience of changing the lens and yet ensuring the authenticity of the secured document.

While embodiments of the invention have been described and illustrated, it will be understood by those skilled in the technology concerned that many variations or modifications in details of design or construction may be made without departing from the invention

1. A method of providing a printed document that can be visually authenticated, comprising the steps of:
generating a message image by applying conversion parameters to a text, the message image being defined by pixels and the message image including a converted text in a first color and a background in a second color;
generating a first pixel array of the same pixel size as the message image by selecting a predefined sub-pixel configuration for each pixel of the first pixel array;
generating a second pixel array corresponding to the first pixel array, wherein where the pixel of the message image is in the second color, a first sub-pixel configuration generated for the second pixel array is identical to the predefined sub-pixel configuration selected for the first pixel array, or where the pixel of the message image is in the first color, a second sub-pixel configuration generated for the second pixel array is inverted relative to the predefined sub-pixel configuration selected for the first pixel array, such that the converted text is hidden in the second pixel array;
transferring the second pixel array to the printed document;
providing the first pixel array rendered on a transparent medium to a user for superimposing on the second pixel array located on the printed document to reveal the converted text to the user.

2. The method according to claim 1, further comprising the step of generating a plurality of second pixel arrays, each of which includes the message image having the converted text, wherein the conversion parameters applied to each message image is not identical to one another resulting in the converted text not being identical to one another.

3. The method according to claim 1, wherein applying the conversion parameters to the text includes selecting the conversion parameters in a random manner to be applied to individual characters of the text to generate the converted text.

4. The method according to claim 3, wherein the conversion parameters include a font, a font size, a position or an orientation of the text or any combination thereof.

5. The method according to claim 1, wherein the step of generating a message image by applying conversion parameters to the text further includes the step of selecting a vertical and horizontal pixel size for the message image.

6. The method according to claim 2, wherein the converted text of each of the message images includes a font, font size, position or orientation of the text, or any combination thereof, which is not identical to the converted text of other message images.

7. The method according to claim 2, wherein the converted text of each of the message images includes individual characters, each of which is of a font, font size, position or orientation of the text, or any combination thereof, which is not identical to the converted text of other message images.

8. The method according to claim 1, wherein the predefined sub-pixel configuration comprises a square two by two configuration of four sub-pixels of which two are in the first color and two are in the second color.

9. The method according to claim 1, wherein the first pixel array and second pixel array includes a guide mark on the same corresponding location of the first pixel array and the second pixel array for guiding the user to superimpose the first pixel array on the second pixel array.

10. The method according to claim 2, further comprising a step of: transferring a plurality of second pixel arrays on a printed document, wherein each of the second pixel arrays include the message image having the converted text, wherein the conversion parameters applied to each message image is not identical to one another.

11. The method according to claim 1, wherein the step of generating the message image further includes generating a character or text or a combination of character or text such that the message image includes the character or text or combination of character or text.

12. A method of providing printed documents that can be visually authenticated, comprising the steps of:
generating a plurality of message images by applying conversion parameters to a text, each of the message images being defined by pixels and each of the message images comprising a converted text in a first color and a background in a second color;
generating a first pixel array of the same pixel size as each of the message images by selecting a predefined sub-pixel configuration for each pixel of the first pixel array;
generating a plurality of second pixel arrays, each corresponding to the first pixel array, and each of the second pixel arrays corresponding to one of the message images, wherein for each of the second pixel arrays, where the pixel of the message images is in the second color, a first sub-pixel configuration generated for the second pixel array is identical to the predefined sub-pixel configuration selected for the first pixel array, or where the pixel of the message images is in the first color, a second sub-pixel configuration generated for the second pixel array is inverted relative to the predefined sub-pixel configuration selected for the first pixel array, such that the converted text is hidden in each of the second pixel arrays;
transferring each of the second pixel arrays to each printed document;
providing the first pixel array rendered on a transparent medium to a user for superimposing on each of the second pixel arrays to reveal each converted text to the user.

13. The method according to claim 12, wherein applying the conversion parameters to the text includes selecting the conversion parameters in a random manner to be applied to individual characters of the text to generate the converted text, wherein the conversion parameters applied to each message image is not identical to one another.

14. The method according to claim 12, wherein the conversion parameters include a font, a font size, a position or an orientation of the text or any combination thereof.

15. The method according to claim 12, wherein the step of generating a plurality of message images by selecting conversion parameters further includes the step of selecting a vertical and horizontal pixel size for each of the message images.

16. The method according to claim 12, wherein the converted text of each of the message images includes a font, font size, position or orientation of the text, or any combination thereof, which is not identical to the converted text of another message image.

17. The method according to claim 12, wherein the converted text of each of the message images includes individual characters, each of a font, font size, position or orientation of the text, or any combination thereof, which is not identical to the converted text of another message image.

18. The method according to claim 12, wherein the predefined sub-pixel configuration comprises a square two by two configuration of four sub-pixels of which two are in the first color and two are in the second color.

19. The method according to claim 12, wherein the first pixel array and second pixel array includes a guide mark on the same corresponding location of the first pixel array and the second pixel array for guiding the user to superimpose the first pixel array on the second pixel array.

20. The method according to claim 12, wherein the step of generating the plurality of message images further includes generating a character or text or a combination of character or text on each message image such that each of the message images includes the character or text or combination of character or text.

21. A method of providing printed documents that can be visually authenticated, comprising the steps of:
generating a plurality of message images by applying conversion parameters to a text, each of the message images being defined by pixels and each of the message images comprising a converted text in a first color and a background in a second color;
generating a first pixel array of the same pixel size as each of the message images by selecting a predefined sub-pixel configuration for each pixel of the first pixel array;
generating a plurality of second pixel arrays, each corresponding to the first pixel array, and each of the second pixel arrays corresponding to one of the message images wherein for each of the second pixel arrays, where the pixel of the message images is in the second color, a first sub-pixel configuration generated for the second pixel array is identical to the predefined sub-pixel configuration selected for the first pixel array, or where the pixel of the message images is in the first color, a second sub-pixel configuration generated for the second pixel array is inverted relative to the predefined sub-pixel configuration selected for the first pixel array, such that the converted text is hidden in each of the second pixel arrays;
transferring the first pixel array to each printed document;
providing each of the second pixel arrays printed on a transparent sheet of material to multiple users for superimposing on the first pixel array to reveal the converted text to each of the multiple users.

22. A system for providing documents that can be visually authenticated, comprising:
a text converter for converting a text to a plurality of message images by applying conversion parameters to the text to convert the text into the plurality of message images, wherein each of the message images is defined by pixels, and each of the message images includes a converted text in a first color and a background in a second color, the converted text in each of the message images are not identical to one another;
a first pixel array generator for generating a first pixel array of the same pixel size as each of the plurality of message images by selecting a predefined sub-pixel configuration for each pixel of the first pixel array;
a second pixel array generator for generating a plurality of second pixel arrays, each corresponding to the first pixel array, and each of the second pixel arrays corresponding to one of the message images, wherein for each of the second pixel arrays, where the pixel of the message images is in the second color, a first sub-pixel configuration generated for the second pixel array is identical to the predefined sub-pixel configuration selected for the first pixel array, or where the pixel of the message images is in the first color, a second sub-pixel configuration generated for the second pixel array is inverted relative to the predefined sub-pixel configuration selected for the first pixel array, such that the converted text is hidden in each of the second pixel arrays;
a printing element for transferring each of the second pixel arrays to printed documents and for transferring the first pixel array to a transparent sheet of material, the first pixel array for superimposing on each of the second pixel arrays on the printed documents to reveal the converted text.

23. The system according to claim 22, wherein applying the conversion parameters to the text includes selecting the conversion parameters in a random manner to be applied to individual characters of the text to generate the converted text.

24. The system according to claim 22, wherein the conversion parameters of the text include a font, a font size, a position or an orientation of the text or any combination thereof.

25. The system according to claim 22, wherein each of the message images has a vertical and horizontal pixel size.

26. The system according to claim 22, wherein the converted text includes a font, font size, position or orientation of the text, or any combination thereof, which is not identical to the converted text of another message image.

27. The system according to claim 22, wherein the predefined sub-pixel configuration comprises a square two by two configuration of four sub-pixels of which two are in the first color and two are in the second color.

28. The system according to claim 22, wherein the first pixel array and second pixel array includes a guide mark on the same corresponding location of the first pixel array and the second pixel array for guiding the user to superimpose the first pixel array on the second pixel array.

29. A method of providing printed documents that can be visually authenticated, comprising the steps of:
generating a plurality of message images by applying conversion parameters to a plurality of texts, each of the message images being defined by pixels and each of the message images comprising a converted text in a first color and a background in a second color;
generating a first pixel array of the same pixel size as each of the message images by selecting a predefined sub-pixel configuration for each pixel of the first pixel array;
generating a plurality of second pixel arrays, each corresponding to the first pixel array, and each of the second pixel arrays corresponding to one of the message images, wherein for each of the second pixel arrays, where the pixel of the message images is in the second color, a first sub-pixel configuration generated for the second pixel array is identical to the predefined sub-pixel configuration selected for the first pixel array, or where the pixel of the message images is in the first color, a second sub-pixel configuration generated for the second pixel array is inverted relative to the predefined sub-pixel configuration selected for the first pixel array, such that the converted text is hidden in each of the second pixel arrays;
transferring each of the second pixel arrays to each printed document;
providing the first pixel array rendered on a transparent medium to a user for superimposing on each of the second pixel arrays to reveal each converted text to the user.
